(19) United States
(12) Patent Application Publication
(10) Pub. No.: US 2014/0046793 A1
(43) Pub. Date: Feb. 13, 2014

(54) METHOD AND SYSTEM OF DISTRIBUTION OF A CONTOURED EXTERIOR 3-D SCULPTURAL LIKENESS

(71) Applicant: Robert A. Mihaly, Rougemont, NC (US)

(72) Inventor: Robert A. Mihaly, Rougemont, NC (US)

(21) Appl. No.: 13/569,258

(22) Filed: Aug. 8, 2012

(51) Int. Cl. G06Q 30/06

(52) U.S. Cl. 705/26.5; 705/27.1

(57) ABSTRACT

The present invention discloses a method of producing and distributing a 3-D likeness of a member of a group, for example, a school situation where student's 3-D likenesses are taken and distributed to the students and is done in a way to provide both the school and the distributor of the likeness a benefit and distribute 3-D likenesses with a contoured exterior.

### COPYRIGHT NOTICE

A portion of the disclosure of this patent contains material that is subject to copyright protection. The copyright owner has no objection to the reproduction by anyone of the patent document or the patent disclosure as it appears in the Patent and Trademark Office patent files or records, but otherwise reserves all copyright rights whatsoever.

### BACKGROUND OF THE INVENTION

1. Field of the Invention

The present invention relates to the production of a contoured exterior 3-D likeness of a school student and distributing the likeness through the school. Further the invention relates to a system of distribution involving schools, their students, and producing a contoured exterior 3-D likeness of the students of the school.

2. Description of Related Art

The marketing of products to students and their relatives through schools has been done for decades. Historically, one of the most common products is the providing of individual and class pictures or photographs. The school photography industry is extremely large and virtually all schools at all levels have some photography program. In lower grade schools and high schools it is not unusual for all the student population to participate as part of required curriculum. Relatives especially parents and close relatives like brothers, sisters, aunts and uncles enjoy, getting the regular pictures that a yearly school photograph presents. The school photography industry is well over a billion dollars a year, and as such, competition for exclusive relationships with schools is fierce since schools normally only establish a relationship with one company.

The change in photography to digital has created a photographic revolution. However, since people take so many photos these days, the interest in school photographs has been decreasing every year. Companies have tried to compensate with more expensive and complicated packages, but clearly the number of people purchasing photographs is going down.

In an attempt to recapture and expand business, many of the companies in this marketing space have added additional products. A first category is the placement of a 2-D photograph on a 3-D object such as mugs and tote bags. Another attempt at 3-D objects presentation is the production of 3-D miniature bas reliefs which are produced from a 2-D photograph. The product is much more a suggestion of an individual student's features than the actual features. They really do not attempt to have any accuracy in the Z (depth) dimension. Other types of 3-D images have been used but are rare for use in student/school situations and in many cases prohibitively expensive for each student or complicated including individual sculpture by hand, internal crystal/glass etched images, prototyping type products, and the like.

### BRIEF SUMMARY OF THE INVENTION

The present invention relates to the discovery that by distributing a contoured exterior 3-D likeness to a member of a group, that distribution of a contoured exterior 3-D likenesses can be achieved, the group can benefit and as well serve the needs of the visually impaired and supplement the sagging school 2-D photography industry.

In one embodiment of the present invention there is a method for providing a product to a group having a plurality of members comprising:
a) establishing a predefined interface with the group for access to the plurality of members at a predetermined date and time;
b) taking a contoured exterior 3-D digital scan of available members that are accessed at the predetermined date and time;
c) storing the scans in a database;
d) ordering a 3-D likeness product by one or more members;
e) manufacturing the ordered contoured exterior 3-D likeness from the member's digital scan stored in the database; and
f) delivering of the ordered contoured exterior 3-D likeness product to the ordering member.

In another embodiment there is a website for an individual to order a contoured exterior 3-D likeness of the individual comprising:
a) a website in communication with a server hosting a database of 3-D image scans of the individual;
b) a website interface for the individual to select a proof of a 3-D image scan of the individual;
c) a website interface for selecting a contoured exterior 3-D likeness to be manufactured; and
d) a website interface for ordering the contoured exterior 3-D likeness.

### BRIEF DESCRIPTION OF THE DRAWINGS

FIG. 1 is a flow relationship diagram of the method of the present invention including the invention website.

FIG. 2 is a simple spacial diagram if the 3-D image process of a group member.

FIG. 3 is a diagram of the website of the invention.

### DETAILED DESCRIPTION OF THE INVENTION

While this invention is susceptible to embodiment in many different forms, there is shown in the drawings and will herein be described in detail specific embodiments, with the understanding that the present disclosure of such embodiments is to be considered as an example of the principles and not intended to limit the invention to the specific embodiments shown and described. In the description below, like reference numerals are used to describe the same, similar or corresponding parts in the several views of the drawings. This detailed description defines the meaning of the terms used herein and specifically describes embodiments in order for those skilled in the art to practice the invention.

### DEFINITIONS

The terms “about” and “essentially” mean±10 percent.

The terms “a” or “an”, as used herein, are defined as one or as more than one. The term “plurality”, as used herein, is defined as two or as more than two. The term “another”, as used herein, is defined as at least a second or more. The terms “including” and/or “having”, as used herein, are defined as comprising (i.e., open language). The term “coupled”, as used herein, is defined as connected, although not necessarily directly, and not necessarily mechanically.

Reference throughout this document to “one embodiment”, “certain embodiments”, and “an embodiment” or similar terms means that a particular feature, structure, or characteristic described in connection with the embodiment is included in at least one embodiment of the present invention. Thus, the appearances of such phrases or in various places throughout this specification are not necessarily all referring to the same embodiment. Furthermore, the particular features, structures, or characteristics may be combined in any suitable manner in one or more embodiments without limitation.

The term “comprising” is not intended to limit inventions to only claiming the present invention with such comprising language. Any invention using the term comprising could be separated into one or more claims using “consisting” or “consisting of” claim language and is so intended.

The term “or” as used herein is to be interpreted as an inclusive or meaning any one or any combination. Therefore, “A, B or C” means any of the following: “A; B; C; A and B; A and C; B and C; A, B and C”. An exception to this definition will occur only when a combination of elements, functions, steps or acts are in some way inherently mutually exclusive.

The drawings featured in the figures are for the purpose of illustrating certain convenient embodiments of the present invention, and are not to be considered as limitation thereto. Term “means” preceding a present participle of an operation indicates a desired function for which there is one or more embodiments, i.e., one or more methods, devices, or apparatuses for achieving the desired function and that one skilled in the art could select from these or their equivalent in view of the disclosure herein and use of the term “means” is not intended to be limiting.

As used herein the term “group” refers to a plurality of people associated to one another because of some common activity. For example, the group of a school has students, teachers and school workers all associated together by virtue of their attendance/work at the school. A workplace could have as a group of people, the people that work at the workplace. A retail store could have the people who shop at the retail store as the group of people with a common activity. While in one embodiment it refers to a single location for the group, e.g. a single school, in other embodiments it could be groups of groups, e.g. a number of schools, like a school district or a business with multiple locations/buildings. Other groups could be easily determined from the disclosure herein. Other groups include for example hospitals, conference centers, affinity group meeting places, funeral homes, pet resorts, resorts, retreats, children's camps, family reunions, weddings, fairs, state fairs, conventions, animal events, other events, daycares, universities, churches, charities, and the like.

As used herein a “predefined interface” with the group is the relationship which establishes access of a contoured exterior 3-D likeness provider to the members of the group. For example the provider might sign an agreement with a school, school district or the like to have access to the students at the school. Likewise, a retail store might have a license with the contoured exterior 3-D provider to sell contoured exterior 3-D likeness to customers. Also if the contoured exterior 3-D provider were directly providing contoured exterior 3-D likeness, the interface would of course be with the provider and him/herself. The interface provides for access to each of the members at a predetermined date and time. For a school that might be one day a year during school hours and for a retail store any time a customer walks into the retail store during business hours. In one embodiment, the interface may also include a profit sharing where the contoured exterior 3-D image provider shares any income with the group. For example, a provider coming to a school can share a portion of the profits with the school as an incentive to hire the provider since the activity can be considered a fundraiser. By the term “access” is meant that the member is available to have a 3-D scan made of the member (e.g. student). One clearly, for a fixed group, would want a day or days when the most number of members can be available.

As used herein the “3-D digital scan” refers to in one embodiment, the 3-D digital scanning apparatus and system or systems which actively emit light and detect its reflection. Such systems include, but are not limited to, structured light, time of flight scanners, triangulation scanners, conoscopic holography scanners, modulated light 3D scanners, laser scanners, parallax, digital correlation, sonar, infrared, high frequency RADAR, 3D Flash LIDAR, LADAR, and/or other 3D scanning technology or highbred systems.

In other embodiments, the 3-D scanning apparatus and system or systems may be passive scanners. Passive scanners produce lower resolution and accuracy than active, light-emitting scanners. Passive scanners do not emit any form of light, relying solely upon detection of reflected ambient radiation. An example technology is multiple-camera stereoscopic systems, which estimate physical contours of the subject through detection of slight imagery variation. A second approach is photometric technology which compares multiple images, with or without varying lighting conditions. A third technology is a silhouette technique employing outlines from a sequence of 2-D images taken at a plurality of angles of the subject.

A stationary, single-source scanner can only reach areas and contours with direct lines of travel by light rays or other electromagnetic waves from source to subject of scan. In an embodiment of the invention, a high-resolution, handheld scanning apparatus addresses this single source limitation. Self-calibrating handheld scanners such as the structured-light-technology Artec MHT™ or the laser-technology Polhemus FastSCAN™ can scan 360 degrees around the subject of the scan. A 3-D polgonal mesh is captured in real-time as either scanning wand is swept over the individual being scanned. The individual's image immediately appears on a computer screen. The real-time visual feedback provides for monitoring and controlling the scan process.

Multiple source or handheld self-calibrating scanners make 360° contoured exterior 3-D likeness sculptures possible. They also make it possible to collect accurate measurements of clothing fabric, shoes, chairs, and so forth. Other items can be included in the scan if desired. For example, a pet, jewelry or similar object. A child in daycare or kindergarten might choose an object such as a “blanky”.

Resolution of the data acquisition employed in this invention cannot be duplicated by methods which seek to produce 3-D models from a single photo. For example, the Artec S™ captures 500,000 3-D measurements with an accuracy of 0.001968″ inches. The combination of technologies and systems integrated the invention herein presented provides for resolution of details unmatched by the prior art. In one embodiment the 3-D scan is less than 360 degrees such as from about 120 degrees to about 270 degrees such that the 3-D likeness produces is essentially the front and sides of the person.

In the present invention the selected scanning method is then utilized to take a 3-D scan of one or more members of the group. In some embodiments it might be all the members, in others just those members who wish to purchase a license, or some combination of these. The scans themselves are in digital format and will need to be saved in a manner they can be accessed later for fabrication of a contoured exterior 3-D likeness.

The 3-D scan can be taken of the head of the person, the head and shoulders, the entire body, a ¾ relief of those types or any full or partial scan including the face of the person.

The scans are loaded into a database for access and storage of the digital information of the 3-D scan. It can also be stored in a database accessible by a website or websites. Scans of individuals are matched, when possible, with fields such as a person's name, a password for accessing the particular scan results, the person's unique identification code, date and time of each scan, identity of 3-D scanning personnel who captured the data, school, retail outlet, salespersons who established and serviced school account, student grades, student identification numbers, homeroom number, teachers, coaches, the class period the student has the teacher, the student's locker number, the student's date of birth, the student's bus number, or other identifiers employed by the school, and the like. One skilled in the art could determine other associated information with the scan. Addresses, phone numbers, and any other contact information for scanned person or representative (e.g. a parent) and school personnel available are saved. Previous records associated with the individual's preferences such as buying history, shopping cart history, browsing history, favorites, viewing history on 3-D likeness company website, customer coupon codes, as well as other data as desired.

Short term database records can be accessed for seasonal sales. For example, In the Spring a parent may receive an email with a 2-D image or video showing a 3-D likeness of their child as a Spring flower. In the Fall that parent might receive an offering displaying a contoured exterior 3-D likeness of their child's face on an orange foam Halloween pumpkin.

Longer term database records might be accessed a decade or two after a schoolchild's 3-D scans. For example, a parent could order a collage of contoured exterior 3-D models taken of a child from kindergarten through the end of grade school or even senior high school graduation. As another example, scans could be ordered of bride and groom from when they were children, at this later date incorporated into wedding table centerpieces or a cake topper. Scans of individuals over time could be combined to produce a morphing movie of the person as they age.

Longer term database records also offer opportunities of attention-getting animations on the website. For example, as a parent browses through the web catalog of products, an animation could play of the parent's child or children morphing and growing from season to season or year to year. Since the data from which such animations is based in full-color, 3-D scans and not mere video, it is possible to make the animation a virtual contoured exterior 3-D environment in which the parent can navigate around the child, viewing the child from different angles as the child digitally progresses through the stages of growing older. Alternatively, with a click of a button, the parent can navigate around the child, viewing the child from every angle as the child moves backward in time, morphing to a younger and younger state.

As used herein the term “proof” of a likenesses of a member refers to a visible image of the 3-D scan in either 2-D or 3-D for the person scanned to review, observe and to decided if the person wishes to buy/acquire a contoured exterior 3-D likeness. This is much like photographic proofs but the final likeness can be much different in presentation than just a photograph. While proofs are optional they aide the purchaser in determining if/what to buy. Proofs could be an extra charge or included free in the purchase of the product. The 3-D data acquired in the scans could be printed out the very day of the scan at the school or other facility. However, it is often desired for editorial and/or marketing reasons to subject the captured contoured exterior 3-D model to some processing. For example, skin and fabric scans predictably with very high resolution. High-resolution 3-D scanners typically find greatest challenge capturing hair. Some styles and colors are harder than others. When hair does not scan well, it can be necessary to artistically model the hair. To sculpt it digitally or otherwise input it into contoured exterior 3-D model form to complete the likeness of the subject. This can be accomplished with well-established 3-D editing and modeling programs such as 3D Studio MAX, 3D Coat, Lightwave, Maya, Rhinoceros 3d, Solidworks, and Blender. In one embodiment the proof is a 3-D likeness created from the digital scan.

3-D proofs are created for each scanned individual. The proofs are provided to the children and/or their parents. The proofs can take one or more of various forms. For example, they can be offered as (a) a set of 2-D images showing multiple views of the contoured exterior 3-D model or models of the child. (b) The 3-D model can be presented as a rotatable/navigable contoured exterior 3-D model. (c) The proof can consist of a video of the contoured exterior 3-D model, rotating in such a way for the customer to perceive it from various angles.

Depending upon the school or other venue, proofs can be offered in digital, printed, or other forms. In some embodiments of the invention, screenshots of the scans can be printed out as proofs the day of the scans. In nearly all cases they are uploaded to a website and made available for customers to contemplate as they browse online 3-D likeness product options.

The offered design and material possibilities could in one embodiment be listed in a printed catalog or be a single offering or a single sheet. In another embodiment a website is utilized to provide proofs and in another embodiment to order one or more 3-D products for a member. A website is usually hosted on a server and made accessible through a particular URL listed website. The database of proofs or anything else desirable can be utilized on the website. However, at times it may be considered advantageous to offer a limited set of options to a particular group. In other embodiments, branded websites are created for specific schools, groups of schools, or other parties. Customized, branded websites might include more premium, expensive products at wealthier-demographic schools. Others might be limited by community and demographic preference. Branded sites also provide for varied pricing structures.

In some embodiments of the invention, an additional feature provides for a software configuration that allows contoured exterior 3-D items (e.g. medium angel earrings, Mrs. Claus and Rudolph Christmas Ornament) to feature the face the child of the member or the child if the child is a member. Where the website presents a large online catalog a parent or third party may do the ordering. Rather than the custom proof appearing at the top or side of the screen as the parent or member navigates through the store, a given parent's child appears on the face of the hundreds or tens of thousands of products in the web store so the parent can visualize what the product might look like with the member's face.

In some embodiments of the invention, tools are available on the site where the member or parent, student, or the like, can create fun and/or interesting customizations online of the 3-D image of the member that is in the database and presented to the website. For example, hairstyles, colors, and headgear can be swapped and modified digitally with digital paint type software. Faces and bodies can be colorized and caricatured. Wings, wheels, sugar, snails, nails, puppy dog tails, antennae and superhero capes can be added and subtracted. A responsive, interactive, graphical user interface allows the consumer to perform a multitude of creative combinations and wacky tweaks in real time.

As used herein the term “contoured exterior 3-D likeness product” refers to a product created from a member 3-D scan (including modified versions done on the website or elsewhere) that are used to create a delivered model including the contoured exterior 3-D image of the member. “Contoured exterior” refers to a natural external relief 3-D model (as a sculpture or bust). As used herein, the term “order” refers to a mechanism for selection of the proof image of the member and the product to be made from the selected 3-D digital image. The item can be free, charged for, or dealt with in any manner known in the art.

A favorite aspect of most parents' lives is their children. The present invention offers parents a system and method whereby they are annually presented with one or a plurality of products celebrating what many consider their greatest treasure. The range of contoured exterior 3-D likeness designs from which they can conveniently and immediately select are multitudinous.

Custom contoured exterior 3-D likeness product jewelry of individual children includes: necklaces, key chains, cameos, intaglios, belt buckles, earrings, bracelets, rings, watches, pendants, charms, brooches, chains, rings, lockets, tie tacks, tie bars, money clips, cufflinks, pins, barrettes, and the like.

Custom contoured exterior 3-D likenesses products toy and game pieces of individual children include: dolls of every size and shape, action figures, hand or finger puppets, book-bag charm, customized chess sets, customized checkers, Monopoly®, other game equipment, and the like.

Custom contoured exterior 3-D likenesses products can take the form of sculptural items in many materials and sizes. This includes sculptures of all sizes from miniature to table-top, half-life, life-size, larger-than-life sculptures, etc.

Custom contoured exterior 3-D likenesses products can take the form of many functional items such as cups, pots, pans, plates, flatware, utensils, silverware, cookie and candy molds, candlesticks, candles, soaps, fridge magnets, manikins, pillows, on pens on pencils, candy dispensers, furniture accents, knobs, computer mouse, lamp, clock, banks, toy chest, all manner of tools, and many other objects.

Custom contoured exterior 3-D likenesses products created from embodiments of this invention can take the form of many seasonal items such as pumpkins, Spring flowers, Christmas or other holiday ornaments, Dickens' Christmas characters, toy soldiers, nut crackers, St. Patrick's Day shamrocks, Fall leaves, etc.

Custom contoured exterior 3-D models created from embodiments of this invention can be employed by creators of custom game equipment, such as users of Sony® PlayStation PS3™. High resolution models resulting from 3-D scans are ideal for modeling helmets, which must fit the human head closely, ideally the PS3™ motion system.

Custom contoured exterior 3-D models created from embodiments of this invention can be employed in the manufacture of robots. This includes novelty robotic toys. It also includes fully-functioning, robots such as Actroid humanoid robots manufactured by the Kokoro Company Ltd. of Tokyo, Japan. The Japanese department store Sogo & Seibu has offered custom humanoid robots manufactured by Kokoro. The system and method of the invention herein may be the most convenient and inexpensive manner for a consumer to attain a 3-D model of him or herself from which a doppelganger robot could be manufactured.

Custom contoured exterior 3-D likenesses products created from embodiments of this invention can take the form of heirlooms such as figurines, keepsake & collectible boxes, bookmarks, and letter openers. Materials such as wood, sterling silver, gold, pewter, porcelain, or the like might be employed.

Custom contoured exterior 3-D likenesses created from embodiments of this invention can take the form of novelty items such as bobble head dolls, coins, chromed or stainless steel hood ornament, soft sculpture dolls, car mirror dangles, party favors, and the like.

Custom contoured exterior 3-D likenesses created from embodiments of this invention can take the form of edible items such as chocolates, cookies, carved fruit, candies, straws, cake toppers, and others.

Custom contoured exterior 3-D models created from embodiments of this invention can be sold in the form of contoured exterior 3-D models. It is not necessary to produce a physical product. These products may be sold in the form of any of many popular 3-D file formats such as 0.3DMF, 0.3DS, .DXF, .POV, .STL, .VRML, or .OBJ files. Such 3-D models may be used in personalized characters for video games. They may be transferred for manufacture to other companies. They can be employed in virtual reality environments, customized instant messaging avatars, animated screen savers, or used in computer animations for artistic or other purposes.

Several embodiments of this invention provide for regular or intermittent 3-D scans of children over a sequence of years. The invention further provides for persistent database storage of 3-D scans. Thus, over a course of years, sequences of high-resolution contoured exterior 3-D models of particular growing children are archived.

Another possible application of this data would be the creation of a virtual reality product in which individuals or their friends and loved ones could replay an individual's growth through the available years. Not a mere video, an entirely 3-D, high resolution morphing of an individual could be played in forward or reverse by morphing the exact geometry from season to season of an individual's growth through the childhood years and beyond. For example, an individual might be fortunate enough to be scanned through an embodiment of this invention once or twice a year from kindergarten through high school. Subsequently, that same individual could, at any time in the future, open up a navigable application wherein the individual could fly through a virtual environment seeing the individual at a younger age, but not just any particular age. One could navigate a virtual environment of one's own physical maturity. Through an input device such as a headset, mouse, joystick, or trackball, one could control the age progression forward and backward. The nature of contoured exterior 3-D models is such that one could view this age progression from any angle, moving or stationary.

The contoured exterior 3-D product may take the form into educational 3-D puzzles, games, and lessons. These and other pedagogical materials may be created through embodiments of the present invention.

Custom contoured exterior 3-D likenesses products created from embodiments of this invention can be decorative such as interior and architectural ornaments, medallions, and plaques. Custom contoured exterior 3-D models created from embodiments of this invention may be used in the manufacture of ephemeral items such as paper, letterhead, note-card embossing, etc.

Often scans are made of siblings on separate days and/or locations. Combining scans of siblings, parents, mentors, best-friends-forever, animals, romantic friends, dinosaurs, robots, and other fantasy characters is possible. Multiple individuals can be combined in such a manner to create different moods. For example, cheek-to-cheek, shoulder-to-shoulder, or lips-to-forehead configurations are evocative of different moods and creative representations. Combining two individuals in one contoured exterior 3-D likeness could be used among high school sweethearts, dances, or prom prior art.

As used herein the term “ordering a contoured exterior 3-D likeness product” refers to the member selecting one or more 3-D proofs of a likeness and selecting one or more contoured exterior 3-D products (as described herein) for delivery by a vendor or the contoured exterior 3-D likeness provider to the member.

As used herein the term “manufacturing the contoured exterior 3-D likenesses product” refers to manufacturing of one of the products listed above. A contoured exterior 3-D likenesses product manufactured in the as function of this invention can be manufactured by any of many available additive 3-D manufacture processes. Possible rapid prototyping (RP) devices include Stereolithography (SLA), Solid Ground Curing (SGC), Laminated Object Manufacturing (LOM), Fused Deposition Modeling (FDM), Selective Laser Sintering (SLS), Ballistic Particle Manufacturing (BPM), Direct Shell Production Casting (DSP), Direct metal laser sintering (DMLS), Thermojet 3D Wax Printer, Electron beam melting (EBM), Multijet Modeling (MJM), and 3D Printing and Deposition Milling (3DP). Z-Corp RP machines create full color models directly from the RP process. Z-Corp's ZPrinter® 650 3-D printer for production, which provides relatively affordable full color products. Accordingly colors may be natural, monochrome, patterned, multi-colored, true tone or artificial tone.

Multi-step hybrid processes such as Multijet Modeling (MJM) to create wax models from which can be employed in additional manufacturing processes. For example, lost-wax casting techniques can produce gold, silver, pewter, other metals and alloys. Regardless of the manufacturing method, every material has desirable specifications for material thickness. As an example, sterling silver jewelry components can be 0.85 mm or less in thickness, but it is desirable for ZCorp's gypsum composite with cyanoacrylate material to be closer to 3 mm thick.

These and other additive, digitally-controlled 3-D manufacturing apparatuses can produce contoured exterior 3-D likenesses product in various materials including thermoplastics, gold, silver, stainless steel, bronze, bronze-infused stainless steel, brass, copper, aluminum, white metals, almost any metal alloy, eutectic metals, photopolymers, paper, titanium alloys, nylon 12, Alumide, ABS plastic, acrylic-based photopolymer, UV-curable acrylic plastic, gypsum composite with cyanoacrylate, porcelains, glazed ceramics, unglazed ceramics, recycled soda-lime glass, vinyl, rubber, resins, etc.

Contoured exterior 3-D likenesses manufactured as a function of this invention can be manufactured by any of many available subtractive 3-D manufacture processes including Computerized Numerical Controlled (CNC) which can be used to mill for the sculpture itself from wax, wood, marble, stone, Styrofoam® or practically any material or preexisting object.

Likenesses produced by either subtractive or additive, digitally-controlled contoured exterior 3-D manufacturing processes may be subjected to subsequent steps including, but not limited to labeling, signing, plating, polishing, painting, coating, dipping, spraying, drying, and glazing. Sometimes contoured exterior 3-D likenesses are created by adding a custom manufactured part to a stock part. For example, a custom contoured exterior 3-D likeness face might be attached to a generic, pre-manufactured body. If desired, mass manufacturing of specific contoured exterior 3-D likenesses may be accomplished by additional processes such as casting, glass blowing, plastic injection, blow molding, extrusion, thermo-forming, and machine molds for die stamping.

As used herein the term “delivery” refers to taking the manufactured product or products and getting them in the hands of the member or any designated person (as in a gift situation). In many embodiments likenesses products are shipped to the member or another party of the member's choosing. In others they may be delivered or mailed to the group.

The components of the present invention require multiple steps and there does not need to be a single entity performing all the steps of the present invention. They can be performed by a plurality of people and/or companies and combined to form the process.

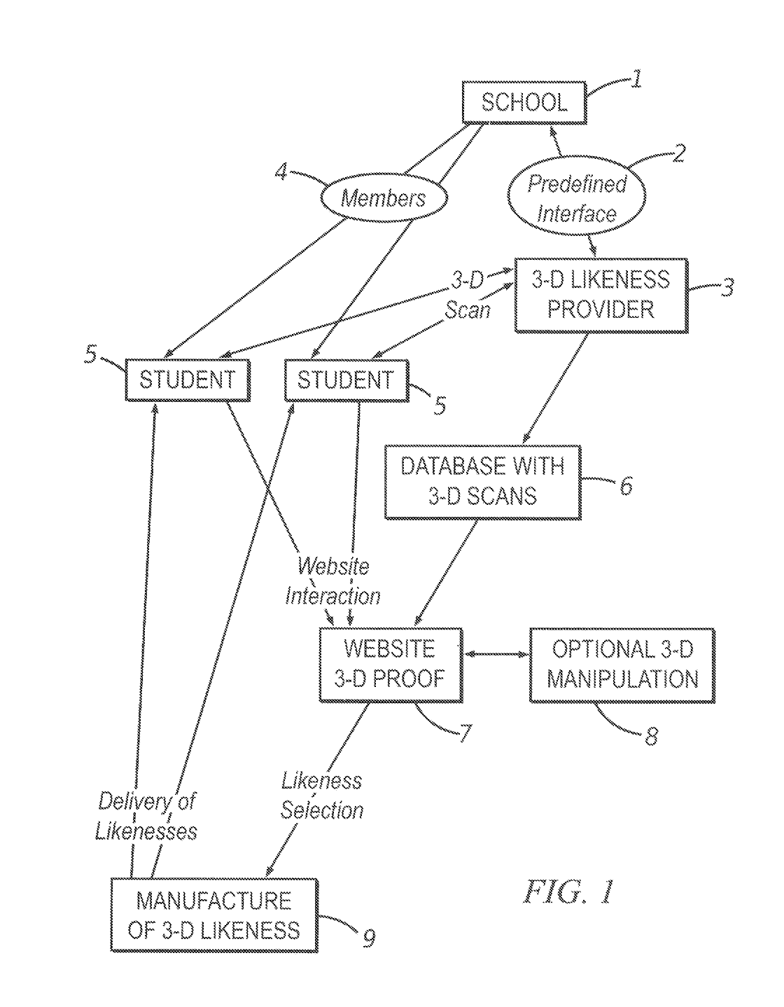

Now referring to the drawings, FIG. 1 is a relationship flow chart of the method of the present invention. School 1 (or other group having members 4 as defined herein) is engaged into a predefined interface 2 (a contract of some kind) with a 3-D likeness provider 3. The predefined interface 2 allows the provider 3 to visit the school 1 and make a 3-D digital scan of each of the student 5 members.

The 3-D scans of each of the students 5 and then transferred from the provider 3 to the 3-D database 6. In this embodiment, the database 6 is then made optionally available to website 7 for website interaction by students 5 (or their representatives) for observation of proofs of the 3-D scans. Optionally the proofs can be manipulated 8 on the website 7. After the selection of the contoured exterior 3-D likeness the selected likeness is manufactured into a 3-D likeness 9 as described above. Once manufactured 9, the lines are delivered back to the student 5.

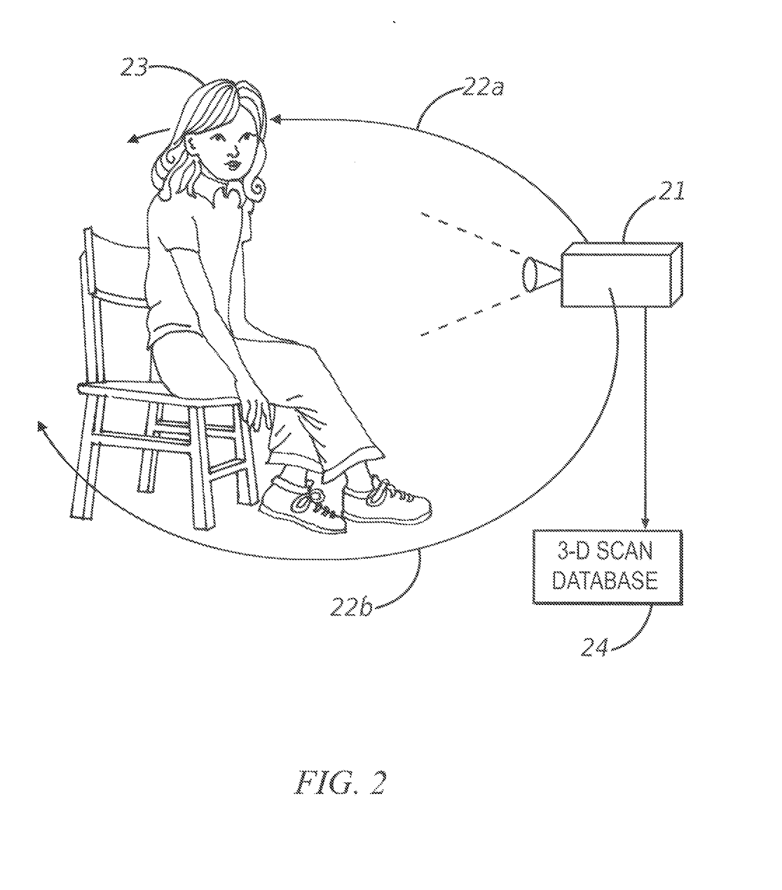

In FIG. 2 there is a simple diagram of taking a partial scan of a member. In this view, hand-held camera 21 can take a 3-D digital image and is hand rotated left and right (arrows 22a and 22b) around student 23 who is sitting in a chair for his picture. The digital scan is then delivered to data base 24 for saving.

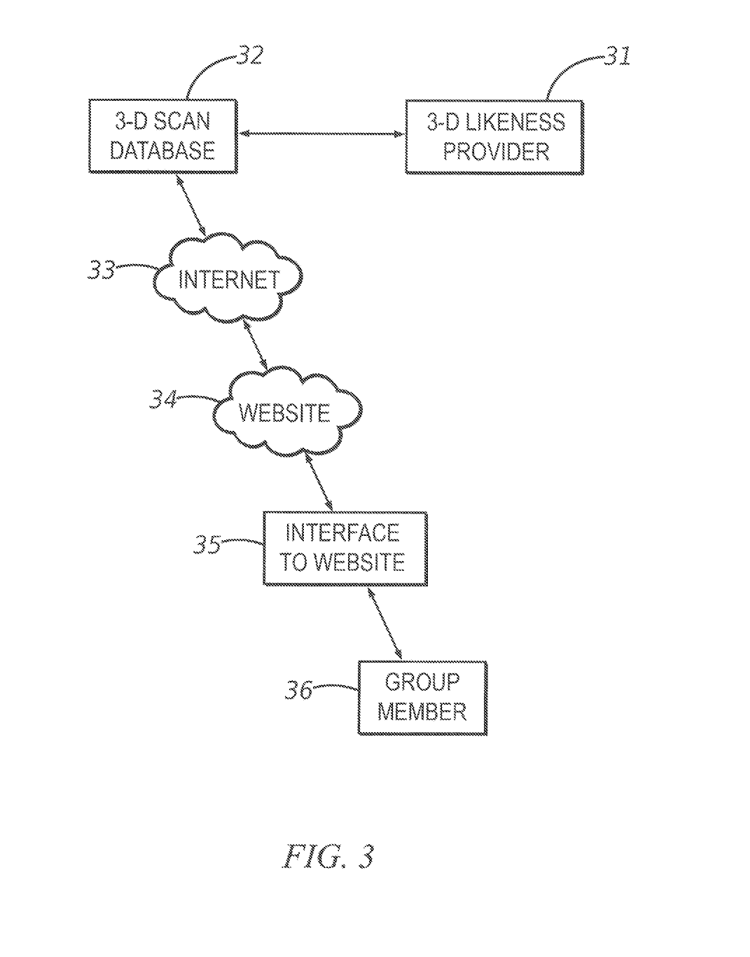

In FIG. 3 there is a relationship drawing of the website of the present invention. In this view a contoured exterior 3-D likeness provider 31 has created a 3-D database 32 of contoured exterior 3-D likenesses of members of a group. The database is delivered to the internet 33 and a website hosted on a server 34 provides an interface to the database and website 35 for use and interaction by the group member 36.

Those skilled in the art to which the present invention pertains may make modifications resulting in other embodiments employing principles of the present invention without departing from its spirit or characteristics, particularly upon considering the foregoing teachings. Accordingly, the described embodiments are to be considered in all respects only as illustrative, and not restrictive, and the scope of the present invention is, therefore, indicated by the appended claims rather than by the foregoing description or drawings. Consequently, while the present invention has been described with reference to particular embodiments, modifications of structure, sequence, materials and the like apparent to those skilled in the art still fall within the scope of the invention as claimed by the applicant.

What is claimed is:

1. A method for providing a product to a group having a plurality of members comprising:
a) establishing a predefined interface with the group for access to the plurality of members at a predetermined date and time;
b) taking a 3-D digital scan of available members that are accessed at the predetermined date and time;
c) storing the scans in a database;
d) ordering a contoured exterior 3-D likeness product by one or more member;
e) manufacturing the ordered contoured exterior 3-D likeness from the member's digital scan stored in the database; and
f) delivering of the ordered contoured exterior 3-D likeness product to the ordering member.

2. The method according to claim 1 wherein the group is a school and the members are selected from the group comprising students and employees of the school.

3. The method according to claim 1 wherein the group is a retail outlet or a business entity.

4. The method according to claim 1 wherein the contoured exterior 3-D likeness is manufactured by a method selected from the group comprising an additive process and a subtractive process.

5. The method according to claim 1 wherein the digital scan of the available members is from a camera rotated in a 360 degree scan.

6. The method according to claim 1 wherein the digital scan is a scan from a camera rotated about 120 degrees to about 270 degrees around the member.

7. The method according to claim 1 wherein the digital scan is made from a plurality of fixed positions.

8. The method according to claim 1 wherein the scan is made from a fixed position.

9. The method according to claim 1 wherein the scan is made with a hand held self calibrating 3-D scanner.

10. The method according to claim 1 wherein there is a website wherein a member can access at least one of likeness proofs of the member, a system to order contoured exterior 3-D likenesses of the member and a system to digitally manipulate the likeness of the member.

11. The method according to claim 1 wherein the proofs are 2-D images.

12. The method according to claim 1 wherein the proofs are 3-D images.

13. The method according to claim 1 wherein multiple 3-D scans of a member are taking over a period of time and combined to form a 3-D morphing video of the member aging.

14. The method according to claim 1 wherein the 3-D scan is of the group comprising the member's head and the member's head and shoulders.

15. The method according to claim 1 wherein the manufactured contoured exterior 3-D likeness comprises 2 or more pieces.

16. The method according to claim 1 wherein the predefined interface comprises the group sharing at least a portion of a profit generated by the method.

17. The method according to claim 1 wherein proofs of the member likeness are provided.

18. A website for an individual to order a contoured exterior 3-D likeness of the individual comprising:
a) a website in communication with a server hosting a database of 3-D image scans of the individual;
b) a website interface for the individual to select a proof of a 3-D image scan of the individual;
c) a website interface for selecting a contoured exterior 3-D likeness to be manufactured; and
d) a website interface for ordering the contoured exterior 3-D likeness.

19. The website according to claim 18 which further comprises an interface on the website which allows digital manipulation of the digital image scan before ordering the contoured exterior 3-D likeness.
